(19) United States
(12) Patent Application Publication
(10) Pub. No.: US 2012/0074112 A1
(43) Pub. Date: Mar. 29, 2012

(54) ARC WELDING METHOD REDUCING OCCURRENCES OF SPATTER AT TIME OF ARC START

(75) Inventors: Shun Kotera, Minamitsuru-gun (JP); Kouji Nakabayashi, Minamitsuru-gun (JP); Hiromitsu Takahashi, Minamitsuru-gun (JP)

(73) Assignee: FANUC Corporation, Minamitsuru-gun (JP)

(21) Appl. No.: 13/215,644

(22) Filed: Aug. 23, 2011

(30) Foreign Application Priority Data
Sep. 24, 2010 (JP) 2010-213940

(51) Int. Cl. B23K 9/007; B23K 9/12

(52) U.S. Cl. 219/124.1

(57) ABSTRACT

An arc welding method which makes a welding torch or welding object which is supported by a robot move and performs arc welding using a welding start point on the welding object as a start point, which method includes a step of feeding a weld wire to the welding start point, a step of stopping the feed of the weld wire after a tip of the weld wire contacts the welding object, a step of supplying a pre-arc welding power in a range where no arc is generated to input heat to the weld wire and the welding object, a step of supplying an arc generating welding power which causes generation of an arc while retracting the weld wire, and a step of supplying main welding power to perform main welding and which method reduces occurrences of spatter at the time of arc start.

### BACKGROUND OF THE INVENTION

1. Field of the Invention

The present invention relates to an arc welding method which reduces occurrences of spatter at the time of arc start.

2. Description of the Related Art

In pulse arc welding which cyclically changes a current to make the current waveform a pulse shape, the “ideal pulse arc welding” uses 1 pulse's worth of output to make the tip of the weld wire melt to form a molten droplet and then separate it from the tip of the weld wire. If the molten droplet at the tip of the weld wire does not separate by 1 pulse's worth of output, the molten metal formed by several pulses' worth of output will build up at the tip of the weld wire until the molten droplet separates, so the molten droplet will grow larger. As a result, temporarily the distance from the molten weld pool on the welding object will become shorter. This causes short-circuits and spatter.

To solve this problem, the technique is generally known of adjusting a peak current value (that is, a value of the critical current or more) and its output time and a base current value (that is, a value of the critical current or less) and its output time in a pulse-like current waveform so as to make a molten droplet separate by 1 pulse's worth of output.

However, the droplet transfer phenomenon where molten metal is transferred from the tip of a weld wire to a welding object is closely related to the material and diameter of the weld wire and the shield gas, so the above adjustment is required for each constitution used. Further, the temperature at the tip part of the weld wire right after arc generation is lower than the temperature of the tip part of the weld wire during subsequent welding, so it tends to be difficult for a molten droplet to be separated by 1 pulse's worth of output.

For this reason, the general practice has been to perform adjustment increasing the above peak current value and its output time only right after arc generation so as to give a larger heat to the tip part of the weld wire to promote its melting and using the pinch effect to separate the molten droplet from the tip of the weld wire. Tremendous labor is required for such adjustment for control of the current waveform.

Further, even if performing such specialized adjustment right after arc generation so as to enable separation of a molten droplet by 1 pulse's worth of output from right after arc generation, a molten weld pool will still not have been formed right after arc generation, so a molten droplet separating from the tip of the weld wire will not stick to the welding object, but will be bounced back and result in spatter.

In this regard, in the pulse arc welding described in JP8-229680A, the increase in the arc length when the molten droplet at the tip of the weld wire separates is electrically detected as an increase in the voltage or resistance value and the welding output is lowered in the interval from the point of time when separation of the molten droplet is detected to when the molten droplet completely transfers to the molten weld pool so as to thereby weaken the arc force against the molten droplet separating from the tip of the weld wire and prevent spatter.

However, even with the pulse arc welding described in JP8-229680A, even if the arc force with respect to the molten droplet separated from the tip of the weld wire is weakened, right after generation of the arc, no molten weld pool is yet formed, so the molten droplet has a hard time sticking to the welding object and is easily bounced back resulting in spatter. If a large amount of spatter occurs at the time of arc start, the spatter will end up sticking to the welding object resulting in a drop in weld quality or resulting in a reduction in the amount of the bead by the amount of melt spattering and therefore an increase in the amount of consumption of the weld wire. Further, in the case of a densely laid out welding system, there is the possibility of the spatter ending up detrimentally affecting other equipment.

### SUMMARY OF THE INVENTION

The present invention, as one aspect, provides an arc welding method which reduces occurrences of spatter at the time of arc start.

The present invention, as one aspect, provides an arc welding method which makes a welding torch or welding object which is supported by a robot move and performs arc welding using a welding start point on the welding object as a start point, which arc welding method includes a step of feeding a weld wire to the welding start point, a step of stopping the feed of the weld wire after a tip of the weld wire contacts the welding object, a step of supplying a pre-arc welding power in a range where no arc is generated to input heat to the weld wire and the welding object, a step of supplying an arc generating welding power which causes generation of an arc while retracting the weld wire, and a step of supplying main welding power to perform main welding and which method reduces occurrences of spatter at the time of arc start.

### BRIEF DESCRIPTION OF THE DRAWINGS

The object, features, and advantages of the present invention will become much clearer in accordance with the following explanation of embodiments given in relation to the attached drawings, in which

FIG. 1 is a block diagram showing an outline of an arc welding system according to one aspect of the present invention,

FIG. 2 is a block diagram showing an outline of an arc welding system according to another aspect of the present invention,

FIG. 3 is a block diagram showing an outline of an arc welding system according to still another aspect of the present invention,

FIG. 4 is a view showing an arc welding method which reduces the occurrences of the spatter according to a first embodiment of the present invention,

FIG. 5 is a view showing an arc welding method which reduces the occurrences of the spatter according to a second embodiment of the present invention,

FIG. 6 is a view showing an arc welding method which reduces the occurrences of the spatter according to a third embodiment of the present invention, and

FIG. 7 is a flowchart of control of arc welding for reducing the occurrences of the spatter at the time of arc start according to the first embodiment to third embodiment of the present invention.

### DESCRIPTION OF THE PREFERRED EMBODIMENTS

Below, embodiments of the present invention will be explained in detail with reference to the drawings. Note that, the method of control according to the different aspects of the present invention is not limited to pulse arc welding and can be applied to all welding.

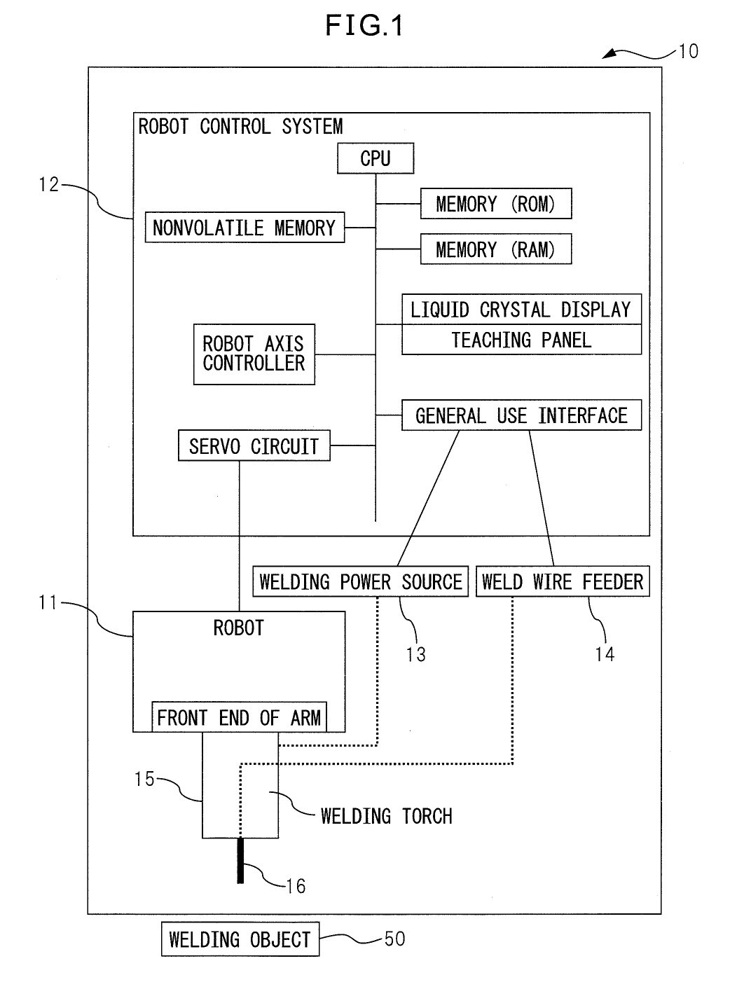

FIG. 1 is a block diagram showing an outline of a first configuration arc welding system 10 according to one aspect of the present invention. The arc welding system 10 has a robot 11, a robot control system 12 which controls a servo motor of the robot 11, a welding power source 13 for arc welding, a weld wire feeder 14, a welding torch 15, and weld wire 16 which is fed/retracted by the weld wire feeder 14.

The robot 11 is a multiarticulated robot which is equipped with a welding torch 15 at the front end part of its arm and which positions the tip of the weld wire 16 extending from the welding torch 15.

The robot control system 12 has parts which are connected to each other by a bidirectional bus such as a CPU (central processing unit), ROM (read only memory), RAM (random access memory), and nonvolatile memory. Further, the robot control system 12 has a liquid crystal display which visually displays an operating state of the robot etc., a teaching panel for a worker to control the robot, a robot axis controller, a servo circuit, and a general use interface to which a welding power source 13 and a weld wire feeder 14 are connected.

According to the first configuration arc welding system 10 according to the present invention, the robot control system 12 controls the robot 11 to position the welding torch 15 above the welding object 50, while the welding power source 13 controls the welding power and the weld wire feeder 14 feeds/retracts weld wire 16 for arc welding the welding object 50.

Note that, the robot 11 may also hold the welding object 50 by an arm and position the welding object 50 with respect to a welding torch fixed at a constant position. Further, the welding power source 13 may also be set outside of the robot control system, but may in particular be assembled into the robot control system.

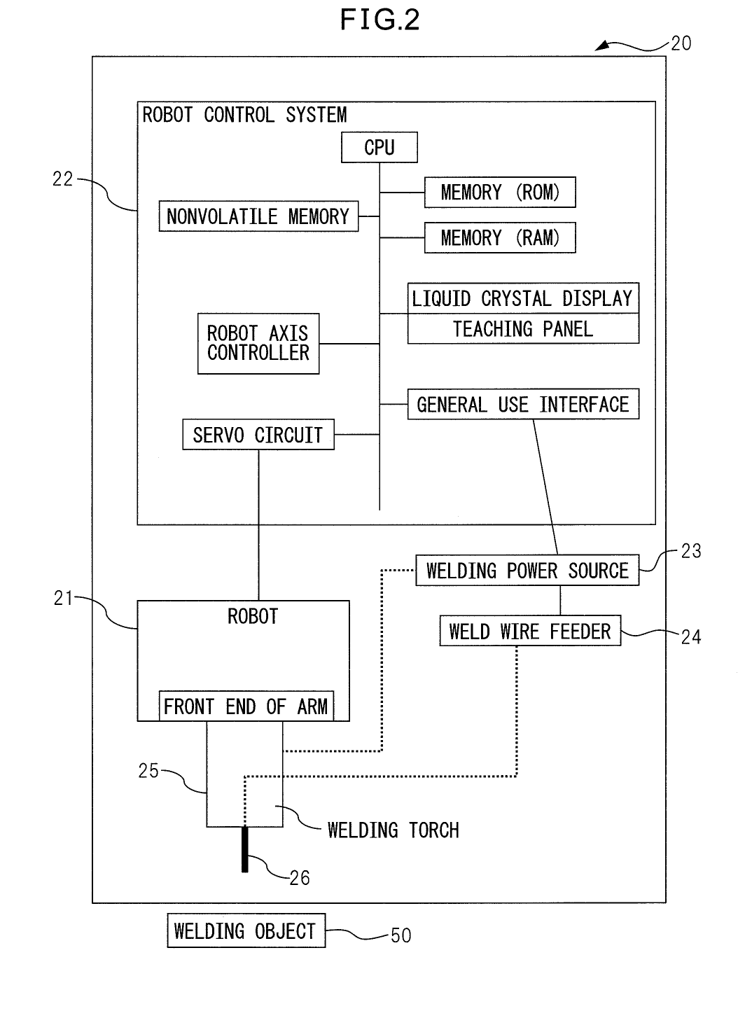

FIG. 2 is a block diagram showing an outline of a second configuration arc welding system 20 according to another aspect of the present invention. The arc welding system 20 has a robot 21, a robot control system 22 which controls a servo motor of the robot 21, a welding power source 23 for arc welding, a weld wire feeder 24, a welding torch 25, and a weld wire 26 which is fed/retracted by the weld wire feeder 24.

The robot 21 is a multiarticulated robot which is equipped with a welding torch 25 at the front end part of its arm and which positions the tip of the weld wire 26 extending from the welding torch 25.

The robot control system 22 has parts which are connected to each other by a bidirectional bus such as a CPU, ROM, RAM, and nonvolatile memory. Further, the robot control system 22 has a liquid crystal display which visually displays an operating state of the robot etc., a teaching panel for a worker to control the robot, a robot axis controller, a servo circuit, and a general use interface to which a welding power source 23 is connected. The second configuration arc welding system 20 differs from the first configuration arc welding system 10 in the point that the weld wire feeder 24 is connected to the welding power source 23.

According to a second configuration arc welding system 20 according to the present invention, the robot control system 22 controls the robot 21 to position the welding torch 25 above the welding object 50, while the welding power source 23 controls the welding power and the weld wire feeder 24 feeds/retracts weld wire 26 for arc welding the welding object 50.

Note that, the robot 21 may also hold the welding object 50 by an arm and position the welding object 50 with respect to a welding torch fixed at a constant position. Further, the welding power source 23 may also be set outside of the robot control system, but may in particular be assembled into the robot control system.

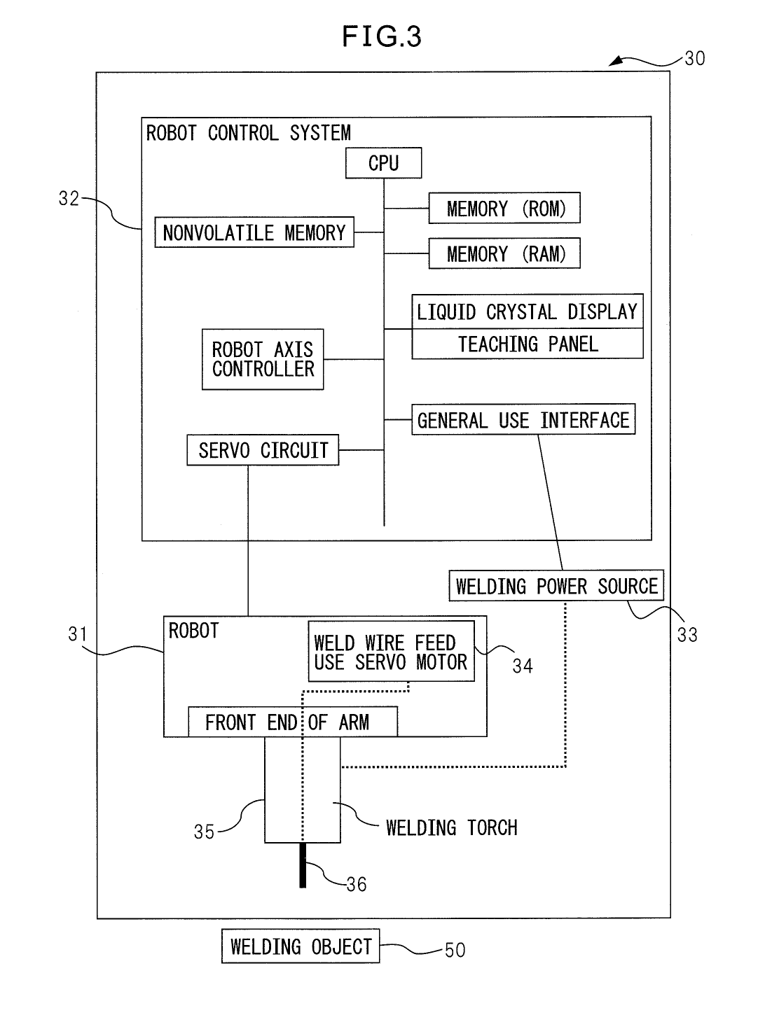

FIG. 3 is a block diagram showing an outline of a third configuration arc welding system 30 according to still another aspect of the present invention. The arc welding system 30 has a robot 31, a robot control system 32 which controls a servo motor of the robot 31, a welding power source 33 for arc welding, a weld wire feed-use servo motor 34, a welding torch 35, and a weld wire 36 which is fed/retracted by the weld wire feed-use servo motor 34.

The robot 31 is a multiarticulated robot which is equipped with a welding torch 35 at the front end part of its arm and which positions the tip of the weld wire 36 extending from the welding torch 35.

The robot control system 32 has parts which are connected to each other by a bidirectional bus such as a CPU, ROM, RAM, and nonvolatile memory. Further, the robot control system 32 has a liquid crystal display which visually displays an operating state of the robot etc., a teaching panel for a worker to control the robot, a robot axis controller, a servo circuit, and a general use interface to which a welding power source 33 is connected. The third configuration arc welding system 30 differs from the first configuration and second configuration arc welding systems in the point that instead of the weld wire feeder, a weld wire feed-use servo motor 34 is arranged inside of the robot 31.

According to the third configuration arc welding system 30 according to the present invention, the robot control system 32 controls the robot 31 to position the welding torch 35 above the welding object 50, while the welding power source 33 controls the welding power and the weld wire feed-use servo motor 34 feeds/retracts weld wire 36 for arc welding the welding object 50.

Note that, the robot 31 may also hold the welding object 50 by an arm and position the welding object 50 with respect to a welding torch fixed at a constant position. Further, the welding power source 33 may also be set outside of the robot control system, but may in particular be assembled into the robot control system.

Further, only naturally, in the first configuration to the third configuration arc welding systems, in addition to the above, various types of sensors are provided for detecting the voltage, current, etc. at the time of welding.

The arc welding methods for reducing the occurrences of the spatter at the time arc start in the first embodiment to the third embodiment of the present invention explained below may also be applied to any of the configurations of the above first configuration to third configuration arc welding systems. Further, only naturally, they may also be applied to arc welding systems having other configurations. In the following explanation, a first configuration arc welding system 10 is used.

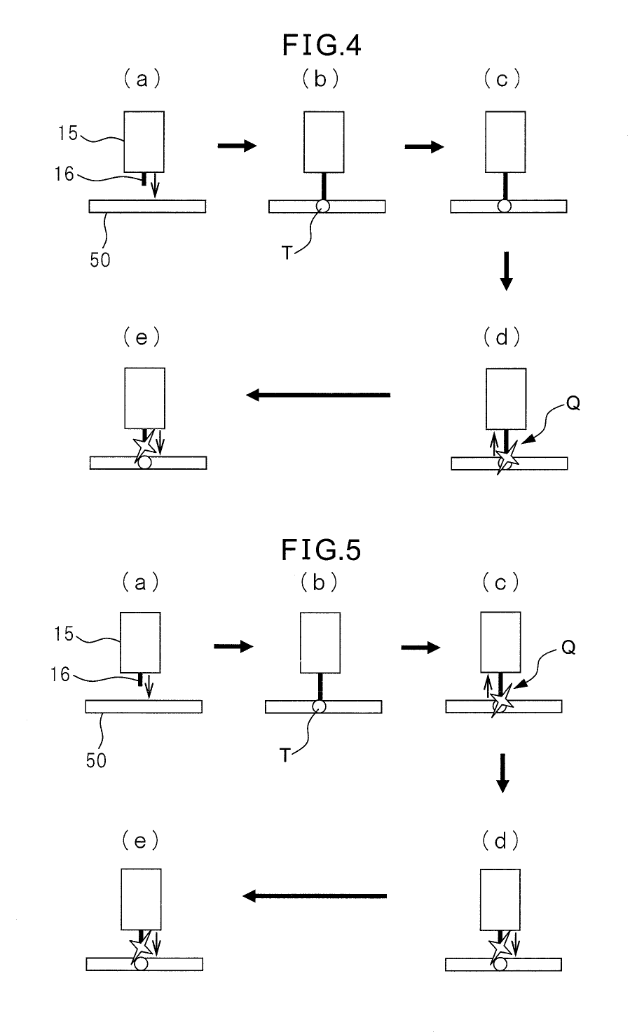

FIG. 4 is a view showing an arc welding method for reducing the occurrences of the spatter at the time of arc start according to a first embodiment of the present invention. The welding torch 15, weld wire 16, and welding object 50 are partially shown.

First, if starting the welding work, the robot control system 12 controls the robot 11 and makes the welding torch 15 move to near the start point for starting the welding, that is, the welding start point T on the welding object 50. When the welding torch 15 reaches near the welding start point T, the robot control system 12 controls the weld wire feeder 14 through the general use interface and feeds the weld wire 16 to the welding start point T (step (a)).

Next, if contact of the tip of the weld wire 16 with the welding start point T is detected (step (b)), the welding power source 13 feeds a predetermined pre-arc welding power P1 to input heat to the weld wire 16 and the surface of welding object 50 (step (c)). The pre-arc welding power P1 is lowered in voltage to a range in which no arc is generated and is set in current value to enable sufficient heat to the input to the weld wire 16 and the surface of welding object 50. The larger the current value is made, the more the heat input to the weld wire 16 and welding object 50 is made.

Next, after the weld wire 16 and the surface of welding object 50 are sufficiently raised in temperature, the weld wire feeder 14 is controlled to retract the weld wire 16 while a predetermined arc generating welding power P2 which is larger than the pre-arc welding power P1 is fed and an arc Q is generated (step (d)). If giving specific examples of the arc generating welding power P2, when the voltage is 2V and the current is 60 A, regardless of the diameter and material of the weld wire and the material and thickness of the welding object, an arc is generated at the instant that the tip of the weld wire separates from the welding object. Therefore, if within the command range of voltage and current which are generally used in the arc welding, an arc can be generated. Next, the main welding power P4 is supplied to perform the main welding (step (e)).

Before starting the main welding (step (e)), the predetermined pre-arc welding power P1 is supplied to input heat to the weld wire 16 and the surface of welding object 50 (step (c)), whereby the weld wire 16 is sufficiently raised in temperature, so, for example, when performing pulse arc welding, it is possible to use 1 pulse's worth of output to melt the tip of the wire make the molten droplet separate. Further, the surface of the welding object 50 is also sufficiently raised in temperature, so even in the state where no molten weld pool is yet formed on the welding object 50, a molten droplet which is separated from the tip of the weld wire 16 may stick to the molten surface of the welding object. Therefore, it is possible to reduce the occurrences of the spatter which occurs when a molten droplet is bounced back without sticking to the welding object 50. Furthermore, since heat is input to the welding start point, the effect is also exhibited that it is possible to increase the amount of penetration near the welding start point at the time of start of main welding.

FIG. 5 is a view showing an arc welding method which reduces the occurrences of the spatter at the time of arc start according to a second embodiment of the present invention. The welding torch 15, weld wire 16, and welding object 50 are partially shown.

First, if starting the welding work, the robot control system 12 controls the robot 11 to make the welding torch 15 move to near the start point for starting the welding, that is, the welding start point T on the welding object 50. When the welding torch 15 reaches near the welding start point T, the robot control system 12 controls the weld wire feeder 14 through the general use interface to feed the weld wire 16 to the welding start point T (step (a)).

Next, if detecting contact of the tip of the weld wire 16 with the welding start point T (step (b)), the robot control system 12 controls the weld wire feeder 14 to retract the weld wire 16 while the welding power source 13 supplies the above-mentioned predetermined arc generating welding power P2 to cause the generation of the arc Q (step (c)).

After the arc Q is generated, the welding power source 13 supplies the predetermined arc maintaining welding power P3 to maintain the arc Q. In this regard, due to the arc maintaining welding power P3, the tip of the weld wire 16 burns off, so the weld wire 16 is fed by the same feed rate as the burnoff rate by which the weld wire 16 becomes shorter due to being burned off. As a result, it becomes possible to maintain a certain arc length, and heat is input to the weld wire 16 and the surface of welding object 50 (step (d)). Next, the main welding power P4 is supplied to perform the main welding (step (e)).

In this regard, the larger the arc maintaining welding power P3, the faster the burnoff rate of the weld wire 16. Further, the burnoff rate changes depending on the diameter and material of the weld wire. Therefore, the suitable feed rate of the weld wire 16 for the burnoff rate of the weld wire 16 is found in advance by experiments.

Here, the method of finding the suitable feed rate of the weld wire will be briefly explained. First, the weld wire to be used and the predetermined arc maintaining welding power are determined and the feed rate of the weld wire is changed in various ways while generating the arc. If the feed rate of the weld wire is too fast, the weld wire and the welding object short-circuit, so it is determined that the feed rate is too fast due to the noise and spatter at the time of short-circuit. To efficiently input heat to the weld wire and the surface of welding object, the tip of the weld wire is preferably as close to the welding object as possible. Therefore, a feed rate of the weld wire which is as fast as possible within a range not causing a short-circuit is the suitable feed rate of the weld wire.

Before starting the main welding (step (e)), the arc Q is used to input heat to the weld wire 16 and the surface of welding object 50 (step (d)) so that the weld wire 16 sufficiently rises in temperature, so for example when performing pulse arc welding, it is possible to cause the tip of the wire to melt and a molten droplet to separate by 1 pulse's worth of output. Further, the surface of the welding object 50 also sufficiently rises in temperature, so even in a state where a molten weld pool is not yet formed on the welding object 50, a molten droplet separated from the tip of the weld wire 16 can be made to stick to the molten welding object surface. Therefore, it is possible to reduce the occurrences of the spatter which occurs when a molten droplet is bounced back without sticking to the welding object 50. Furthermore, since heat is input to the welding start point, the effect is also exhibited that it is possible to increase the amount of penetration near the welding start point at the time of start of main welding.

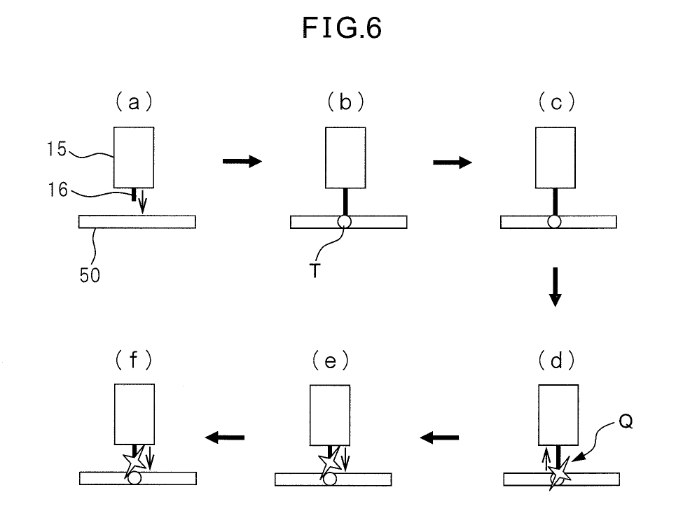

FIG. 6 is a view showing an arc welding method which reduces the occurrences of the spatter at the time of arc start according to a third embodiment of the present invention. The welding torch 15, weld wire 16, and welding object 50 are partially shown.

First, if starting the welding work, the robot control system 12 controls the robot 11 to make the welding torch 15 move to near the start point for starting the welding, that is, the welding start point T on the welding object 50. When the welding torch 15 reaches near the welding start point T, the robot control system 12 controls the weld wire feeder 14 through the general use interface to feed the weld wire 16 to the welding start point T (step (a)).

Next, if detecting contact of the tip of the weld wire 16 with the welding start point T (step (b)), the welding power source 13 supplies the above-mentioned predetermined pre-arc welding power P1 to input heat to the weld wire 16 and the surface of welding object 50 (step (c)).

Next, after the weld wire 16 and the surface of welding object 50 have risen in temperature, the robot control system 12 controls the weld wire feeder 14 to retract the weld wire 16 while the welding power source 13 supplies the above-mentioned predetermined arc generating welding power P2 to cause the generation of the arc Q (step (d)).

After the arc Q is generated, the welding power source 13 supplies the predetermined arc maintaining welding power P3 to maintain the arc Q and input heat to the weld wire 16 and the surface of welding object 50 (step (e)). Next, the main welding power P4 is supplied to perform the main welding (step (f)).

Before starting the main welding (step (f)), the predetermined pre-arc welding power P1 is supplied to input heat to the weld wire 16 and the surface of welding object 50 (step (c)) and, further, the arc Q is used to input heat to the weld wire 16 and the surface of welding object 50 (step (e)) so that the weld wire 16 sufficiently rises in temperature, so for example when performing pulse arc welding, it is possible to cause the tip of the wire to melt and a molten droplet to separate by 1 pulse's worth of output. Further, the surface of the welding object 50 also sufficiently rises in temperature, so even in a state where a molten weld pool is not yet formed on the welding object 50, a molten droplet separated from the tip of the weld wire 16 can be made to stick to the molten welding object surface. Therefore, it is possible to reduce the occurrences of the spatter which occurs when a molten droplet is bounced back without sticking to the welding object 50. Furthermore, since heat is input to the welding start point, the effect is also exhibited that it is possible to increase the amount of penetration near the welding start point at the time of start of main welding.

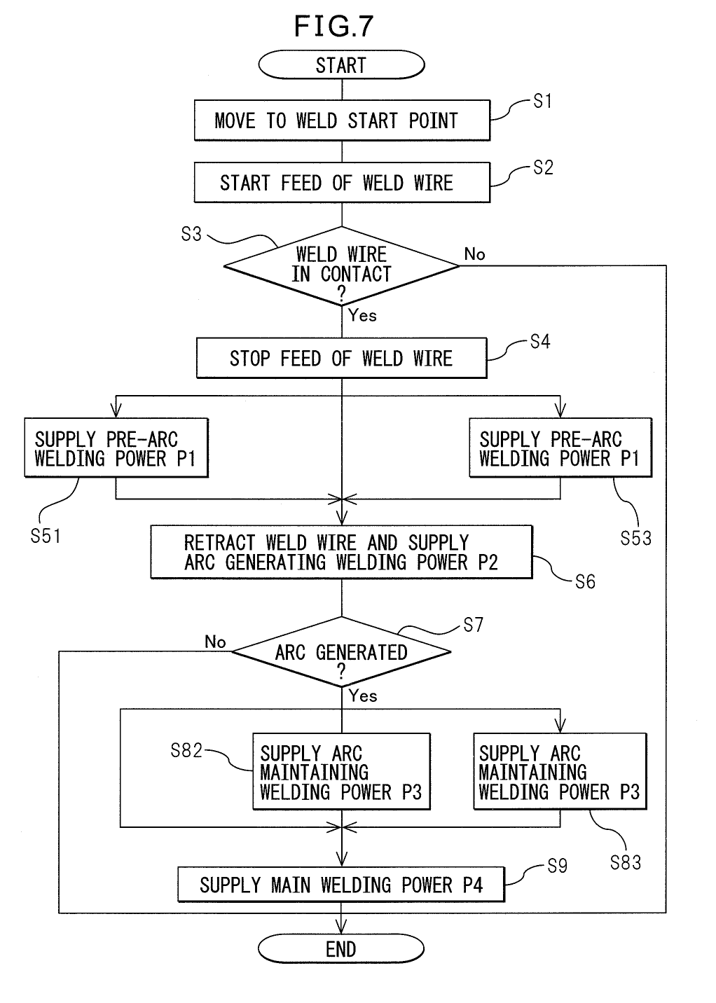

FIG. 7 is a flowchart of control of arc welding for reducing the occurrences of the spatter at the time of arc start according to the first embodiment to third embodiment of the present invention. In the same way as the explanation of the above embodiment, the explanation will be given below taking as an example the first configuration arc welding system 10.

When a worker etc. runs a robot program for performing arc welding, first, at step S1, the welding torch 15 is made to move to near the welding start point T, then the routine proceeds to step S2. Next, at step S2, the feed of the weld wire 16 is started, then the routine proceeds to step S3. Next, at step S3, it is determined if the tip of the weld wire 16 has contacted the welding start point T of the welding object 50. If at step S3 the tip of the weld wire 16 has not contacted the welding start point T within a predetermined time, it may be considered to perform various processes known in the past, but here the processing is ended.

On the other hand, if at step S3 the tip of the weld wire 16 has contacted the welding start point T, the routine proceeds to step S4. Next, at step S4, the feed of the weld wire 16 is stopped. Next, in the case of control by the first embodiment, the routine proceeds to step S51, in the case of control by the second embodiment, the routine proceeds to step S6, and in the case of control by the third embodiment, the routine proceeds to step S53.

When in the first embodiment the routine proceeds to step S51 or when in the third embodiment the routine proceeds to step S53, the predetermined pre-arc welding power P1 is supplied to input heat to the weld wire 16 and the surface of welding object 50, then the routine proceeds to step S6. Next, at step S6, the weld wire 16 is retracted and the arc generating welding power P2 is supplied, then the routine proceeds to step S7. Next, at step S7, it is determined if the processing of step S6 has caused an arc Q to form. If at step S7 no arc Q has been generated, it may be considered to perform various processes known in the past, but here the processing is ended.

On the other hand, if at step S7 an arc Q has been generated, in the case of control by the first embodiment, the routine proceeds to step S9, in the case of control by the second embodiment, the routine proceeds to step S82, and in the case of control by the third embodiment, the routine proceeds to step S83.

When in the second embodiment the routine proceeds to step S82 or when in the third embodiment the routine proceeds to step S83, the arc maintaining welding power P3 is supplied to input heat to the weld the surface of wire 16 and welding object 50, then the routine proceeds to step S9. Next, at step S9, the main welding is started, welding is performed along with a predetermined program, and then the processing is ended.

As explained above, according to the present invention, it is possible to reduce the occurrences of the spatter at the time of start of the arc, so the advantageous effects are exhibited that the weld quality is improved, the amount of consumption of the weld wire is reduced and thereby costs are slashed, and spatter is no longer caused so dense layout of the welding system becomes possible.

Due to the above, in a first aspect of the present invention, there is provided an arc welding method which makes a welding torch or welding object which is supported by a robot move and performs arc welding using a welding start point on the welding object as a start point, which arc welding method includes a step of feeding a weld wire to the welding start point, a step of stopping the feed of the weld wire after a tip of the weld wire contacts the welding object, a step of supplying a pre-arc welding power in a range where no arc is generated to input heat to the weld wire and the welding object, a step of supplying an arc generating welding power which causes generation of an arc while retracting the weld wire, and a step of supplying main welding power to perform main welding and which method reduces the occurrences of the spatter at the time of arc start.

Further, in a second aspect of the present invention, there is provided an arc welding method which makes a welding torch or welding object which is supported by a robot move and performs arc welding using a welding start point on the welding object as a start point, which arc welding method includes a step of feeding a weld wire to the welding start point, a step of stopping the feed of the weld wire after a tip of the weld wire contacts the welding object, a step of retracting the weld wire while supplying an arc generating welding power which causes generation of an arc, a step of supplying an arc maintaining welding power for inputting heat to the weld wire and the welding object and feeding the weld wire by the same feed rate as a burnoff rate by which the tip of the weld wire burns off due to the arc maintaining welding power, and a step of supplying main welding power to perform main welding and which method reduces the occurrences of the spatter at the time of arc start.

Further, in a third aspect of the present invention, there is provided an arc welding method which makes a welding torch or welding object which is supported by a robot move and performs arc welding using a welding start point on the welding object as a start point, which arc welding method includes a step of feeding a weld wire to the welding start point, a step of stopping the feed of the weld wire after a tip of the weld wire contacts the welding object, a step of supplying a pre-arc welding power in a range where no arc is generated to input heat to the weld wire and the welding object, a step of retracting the weld wire while supplying an arc generating welding power which causes generation of an arc, a step of supplying an arc maintaining welding power for inputting heat to the weld wire and the welding object and feeding the weld wire by the same feed rate as a burnoff rate by which the tip of the weld wire burns off due to the arc maintaining welding power, and a step of supplying main welding power to perform main welding and which method reduces the occurrences of the spatter at the time of arc start.

In the first to third aspects of the present invention, before starting the main welding, heat is input to the weld wire and welding object. Therefore, the effect of increasing the amount of penetration at the welding start point, the effect of a molten droplet sticking to the molten surface of the welding object in a state where a molten weld pool has not yet formed on the welding object, and the effect that when performing pulse arc welding, melting of the tip of the weld wire is promoted, so a molten droplet is separated from the tip of the weld wire from the time of arc start by 1 pulse's worth of output.

Therefore, according to the aspects of the present invention, the common effect is exhibited of reduction of the occurrences of the spatter at the time of arc start.

Above, the present invention was explained with reference to its preferred embodiments, but that fact that it can be modified and changed in various ways without departing from the scope of the disclosure of the later explained claims would be understood by a person skilled in the art.

1. An arc welding method which makes a welding torch or welding object which is supported by a robot move and performs arc welding using a welding start point on said welding object as a start point, the arc welding method comprising:
feeding a weld wire to said welding start point,
stopping the feed of said weld wire after a tip of said weld wire contacts said welding object,
supplying a pre-arc welding power in a range where no arc is generated to input heat to said weld wire and said welding object,
supplying an arc generating welding power which causes generation of an arc while retracting the weld wire, and
supplying main welding power to perform main welding,
wherein the arc welding method reduces occurrences of spatter at the time of arc start.

2. An arc welding method which makes a welding torch or welding object which is supported by a robot move and performs arc welding using a welding start point on said welding object as a start point, the arc welding method comprising:
feeding a weld wire to said welding start point,
stopping the feed of said weld wire after a tip of said weld wire contacts said welding object,
supplying an arc generating welding power which causes generation of an arc while retracting the weld wire,
supplying an arc maintaining welding power for inputting heat to said weld wire and said welding object and feeding said weld wire by the same feed rate as a burnoff rate by which the tip of said weld wire burns off due to said arc maintaining welding power, and
supplying main welding power to perform main welding,
wherein the arc welding method reduces occurrences of spatter at the time of arc start.

3. An arc welding method which makes a welding torch or welding object which is supported by a robot move and performs arc welding using a welding start point on said welding object as a start point, the arc welding method comprising:
feeding a weld wire to said welding start point,
stopping the feed of said weld wire after a tip of said weld wire contacts said welding object,
supplying a pre-arc welding power in a range where no arc is generated to input heat to said weld wire and said welding object,
supplying an arc generating welding power which causes generation of an arc while retracting the weld wire,
supplying an arc maintaining welding power for inputting heat to said weld wire and said welding object and feeding said weld wire by the same feed rate as a burnoff rate by which the tip of said weld wire burns off due to said arc maintaining welding power, and
supplying main welding power to perform main welding,
wherein the arc welding method reduces occurrences of spatter at the time of arc start.
